(19) United States
(12) Patent Application Publication
(10) Pub. No.: US 2008/0273204 A1
(43) Pub. Date: Nov. 6, 2008

(54) Apparatus and Method for Measuring the Spectral Properties of a Fluid

(75) Inventors: Carlos Arthur Leaes Peixoto, Porto Alegre (BR); Eduardo Schotgues, Porto Alegre (BR); Paulo Ricardo Pfeil, Sao Leopoldo (BR)

Correspondence Address: HARNESS, DICKEY & PIERCE, P.L.C., P.O. BOX 828, BLOOMFIELD HILLS, MI, 48303, US

(73) Assignee: RENNER HERRMANN S.A., Poroto Alegre (BR)

(21) Appl. No.: 11/597,160

(22) PCT Filed: May 25, 2004
(86) PCT No.: PCT/BR04/00075

§ 371 Date: Oct. 29, 2007

(51) Int. Cl. G01N 21/00

(52) U.S. Cl. 356/436

(57) ABSTRACT

An apparatus and method for measuring the spectral properties of a paint, dye, enamel or other opaque fluid, both in transmission and reflection, wherein a lock-in amplifier (5) is used to increase substantially the signal-to-noise ratio of transmitted components of electromagnetic radiation passing through the fluid, thereby enabling transmittance measurements to be made to the order of 0.0001% or less of the incident electromagnetic radiation.

### TECHNICAL FIELD

The present invention relates to an apparatus and method for measuring the spectral properties, such as the absorption coefficient, scattering coefficient and colour of fluids or fluid emulsions, such as paints, enamels and dyes, so that the strength, hiding power and colour of a batch of the fluid can be determined, and can be altered so as to correspond to a desired strength, hiding power and colour.

### BACKGROUND ART

In a paint, enamel or dye production process, raw materials are mixed together in different proportions to produce a fluid having a set of desired physical properties. One problem with this is that, due to variations inherent to the raw materials used, it is not possible simply to mix the same proportions of raw materials and obtain a resultant fluid having the required specifications. It is necessary, therefore, to measure various spectral properties of the fluid as it is being prepared in order to be able to adjust the proportions of the raw materials so as to produce the desired fluid emulsion.

The properties of a fluid that need to be measured in order to conform to a desired specification are the absorption coefficient, scattering coefficient, particle size, colour, viscosity and density. While it is relatively easy to measure the colour, viscosity and density of a fluid, it is less easy to obtain absolute values for the absorption coefficient, scattering coefficient and particle size. By measuring the transmittance and reflectance of a fluid it is possible to obtain spectral curves characteristic of the absorption and scattering coefficients of the fluid.

Patent application PCT/BR1996/00046 describes a technique using a variable path length fluid analysis cell which can be used for measuring both reflection and transmission spectra of a paint, enamel or dye during the production process. This technique uses a spectrophotometer to measure the transmittance and/or reflectance of a sample of the fluid.

Where highly opaque fluids are concerned as in the case of paints, it is relatively easy to obtain a reflection spectrum, since the reflected radiation is usually of sufficient intensity to be easily detectable without too much background noise. However, it is more difficult to obtain a transmission spectrum for highly opaque fluids, because the intensity of the radiation transmitted through the sample is highly attenuated, to the extent that the transmitted signal can be lost in background noise. Typically, using currently available spectrophotometers, it is possible to measure transmittances of down to 0.1%. This lower limit on transmittance measurements is due to large extent on the specification of stray light of the spectrophotometer.

One technique that may be used to overcome this is to dilute the sample by a known dilution, typically in the case of paints, enamels and dyes it is necessary to dilute the fluid in the ratio of between 1 to 100 to 1 to 10,000, depending on the opacity, which means that the sample being analysed is not exactly the same as the paint, enamel or dye mixture under investigation, leading to uncertainties in the measurement.

Another technique that may be used to overcome the problem is to use very thin films of the fluid so that the transmittance is higher. This latter technique has the drawback that the radiation may not interact sufficiently with the fluid to provide a useful transmission spectrum.

In order to be able to make transmission measurements of opaque fluids, without diluting the fluid, and where the sample cross-section has a sufficient thickness such that there is interaction between the radiation ant the fluid, it is necessary to be able to measure transmittances down to 0.0001% or less.

### OBJECT OF THE INVENTION

The object of the present invention is to provide an apparatus and a method for measuring the spectral properties of a fluid, which significantly increases the sensitivity of the measurement, in order to overcome the above mentioned problems in the state of the art, and thereby allow the spectral characteristics of the fluid to be adjusted to conform to desired spectral characteristics.

### SUMMARY OF THE INVENTION

According to a first aspect of the present invention, an apparatus for measuring the spectral properties of a fluid comprises:
(i) an electromagnetic radiation generator, having a source of electromagnetic radiation and a modulator, for producing a modulated electromagnetic radiation signal;
(ii) a phase reference electromagnetic radiation detector, in communication with the electromagnetic radiation generator, for detecting the modulated electromagnetic radiation signal to produce an electrical modulated phase reference signal representing the modulated electromagnetic radiation signal;
(iii) a tuner, in communication with the electromagnetic radiation generator, for tuning the modulated electromagnetic radiation signal to produce a modulated substantially monochromatic electromagnetic radiation signal;
(iv) a fluid analysis cell, in communication with the tuner, adapted to allow the modulated substantially monochromatic electromagnetic radiation signal, to interact in transmission with a fluid within the fluid analysis cell, to produce a first modulated transmission signal;
(v) a first transmitted electromagnetic radiation detector, in communication with the fluid analysis cell, for detecting the first modulated transmission signal to produce a first electrical modulated transmission sample signal representing the first modulated transmission signal; and
(vi) a lock-in amplifier, in communication with the phase reference and first transmitted electromagnetic radiation detectors, adapted to demodulate the first electrical modulated transmission sample signal to produce a first electrical demodulated transmission sample signal representing the spectral properties in transmission of the fluid.

For preference, the apparatus additionally comprises a reference intensity electromagnetic radiation detector, in communication with the tuner, for detecting the modulated substantially monochromatic electromagnetic radiation signal to produce an electrical modulated electromagnetic radiation reference intensity signal representing the modulated substantially monochromatic electromagnetic radiation signal. In this case, the lock-in amplifier is in communication with the reference intensity electromagnetic radiation detector and is capable of using the modulated electromagnetic radiation reference intensity signal to compensate for intensity fluctuations of the source.

Preferably, the fluid analysis cell is adapted to allow the modulated substantially monochromatic electromagnetic radiation signal, to interact with a fluid within the cell, to produce a second modulated transmission signal, simultaneously with the first modulated transmission signal, the apparatus comprising a second transmitted electromagnetic radiation detector, in communication with the fluid analysis cell, for detecting the second modulated transmission signal to produce a second electrical modulated transmission sample signal representing the second modulated transmission signal. In this case, the lock-in amplifier is in communication with the second transmitted electromagnetic radiation detector, and is adapted to demodulate the second electrical modulated transmission sample signal to produce a second electrical demodulated transmission sample signal representing the spectral properties in transmission of the fluid.

For further preference, the fluid analysis cell is adapted to allow the modulated substantially monochromatic electromagnetic radiation signal, to interact in reflection with a fluid within the fluid analysis cell, to produce a modulated reflection signal. In this case, the apparatus also comprises a reflected electromagnetic radiation detector, in communication with the fluid analysis cell, for detecting the modulated reflection signal to produce an electrical modulated reflection sample signal representing the modulated reflection signal. Also, the lock-in amplifier is adapted to demodulate the electrical modulated reflection sample signal, to produce an electrical demodulated reflection sample signal representing the spectral properties of the fluid.

More preferably still, the apparatus comprises means for isolating the modulated reflection signal from the first and/or second modulated transmission signals, such that transmission and reflection measurements may be made simultaneously.

For still further preference, the source of electromagnetic radiation is a xenon short arc lamp, and the modulator is a chopper.

Even more preferably, the tuning means is a monochromator.

According to a second aspect of the present invention, an apparatus for measuring the spectral properties of a fluid comprises:
(i) an electromagnetic radiation generator, having a source of electromagnetic radiation and a modulator, for producing a modulated electromagnetic radiation signal;
(ii) a phase reference electromagnetic radiation detector, in communication with the electromagnetic radiation generator, for detecting the modulated electromagnetic radiation signal to produce an electrical modulated phase reference signal representing the modulated electromagnetic radiation signal;
(iii) a first tuner, in communication with the electromagnetic radiation generator, for tuning the modulated electromagnetic radiation signal to produce a modulated substantially monochromatic electromagnetic radiation signal;
(iv) a fluid analysis cell, in communication with the tuner, adapted to allow the modulated substantially monochromatic electromagnetic radiation signal, to interact in transmission with a fluid within the fluid analysis cell, to produce a first modulated transmission signal;
(v) a second tuner, in communication with the fluid analysis cell, for tuning the first modulated transmission signal to produce a substantially monochromatic first modulated transmission signal;
(vi) a first transmitted electromagnetic radiation detector, in communication with the second tuner, for detecting the substantially monochromatic first modulated transmission signal to produce a first electrical modulated transmission sample signal representing the substantially monochromatic first modulated transmission signal; and
(vii) a lock-in amplifier, in communication with the phase reference and the first transmitted electromagnetic radiation detectors, adapted to demodulate the first electrical modulated transmission sample signal to produce a first electrical demodulated transmission sample signal representing the spectral properties in transmission of the fluid.

For preference, the apparatus additionally comprises a reference intensity electromagnetic radiation detector, in communication with either the first tuner or second tuner, for detecting the modulated substantially monochromatic electromagnetic radiation signal to produce an electrical modulated electromagnetic radiation reference intensity signal representing the modulated substantially monochromatic electromagnetic radiation signal. In this case, the lock-in amplifier is in communication with the reference intensity electromagnetic radiation detector and is capable of using the modulated electromagnetic radiation reference intensity signal to compensate for intensity fluctuations of the source.

Preferably, the fluid analysis cell is adapted to allow the modulated substantially monochromatic electromagnetic radiation signal, to interact with a fluid within the cell, to produce a second modulated transmission signal simultaneously with the first modulated transmission signal, the apparatus comprising a second transmitted electromagnetic radiation detector, in communication with the second tuner, for detecting the second modulated transmission signal to produce a second electrical modulated transmission sample signal representing the second modulated transmission signal. In this case, the lock-in amplifier is in communication with the second transmitted electromagnetic radiation detector, and is adapted to demodulate the second electrical modulated transmission sample signal to produce a second electrical demodulated transmission sample signal representing the spectral properties in transmission of the fluid.

For further preference, the fluid analysis cell is adapted to allow the modulated substantially monochromatic electromagnetic radiation signal, to interact in reflection with a fluid within the fluid analysis cell, to produce a modulated reflection signal. In this case, the apparatus also comprises a reflected electromagnetic radiation detector, in communication with the second tuner, for detecting the modulated reflection signal to produce an electrical modulated reflection sample signal representing the modulated reflection signal. Also, the lock-in amplifier is adapted to demodulate the electrical modulated reflection sample signal, to produce an electrical demodulated reflection sample signal representing the spectral properties of the fluid.

More preferably still, the apparatus comprises means for isolating the modulated reflection signal from the first and/or second modulated transmission signals, such that transmission and reflection measurements may be made simultaneously.

For still further preference, the source of electromagnetic radiation is a xenon short arc lamp, and the modulator is a chopper.

Even more preferably, the first and second tuners are monochromators.

According to a third aspect of the present invention, an apparatus for measuring the spectral properties of a fluid comprises:
(i) an electromagnetic radiation generator, having a source of electromagnetic radiation and a modulator, for producing a modulated electromagnetic radiation signal;
(ii) a phase reference electromagnetic radiation detector, in communication with the electromagnetic radiation generator, for detecting the modulated electromagnetic radiation signal to produce an electrical modulated phase reference signal representing the modulated electromagnetic radiation signal;
(iii) a fluid analysis cell, in communication with the electromagnetic radiation generator, adapted to allow the modulated electromagnetic radiation signal, to interact in transmission with a fluid within the fluid analysis cell, to produce a first modulated transmission signal;
(iv) a tuner, in communication with the fluid analysis cell, for tuning the first modulated transmission signal to produce a substantially monochromatic first modulated transmission signal;
(v) a first transmitted electromagnetic radiation detector, in communication with the tuner, for detecting the substantially monochromatic first modulated transmission signal to produce a first electrical modulated transmission sample signal representing the substantially monochromatic first modulated transmission signal; and
(vi) a lock-in amplifier, in communication with the phase reference and the first transmitted electromagnetic radiation detectors, adapted to demodulate the first electrical modulated transmission sample signal to produce a first electrical demodulated transmission sample signal representing the spectral properties in transmission of the fluid.

For preference, the apparatus additionally comprises a reference intensity electromagnetic radiation detector, in communication with the tuner, for detecting the substantially monochromatic first modulated transmission signal to produce an electrical modulated electromagnetic radiation reference intensity signal representing the substantially mono-chromatic first modulated transmission signal. In this case, the lock-in amplifier is in communication with the reference intensity electromagnetic radiation detector and is capable of using the modulated electromagnetic radiation reference intensity signal to compensate for intensity fluctuations of the source.

Preferably, the fluid analysis cell is adapted to allow the modulated electromagnetic radiation signal, to interact with a fluid within the fluid analysis cell, to produce a second modulated transmission signal simultaneously with the first modulated transmission signal, and the tuner is in communication with the fluid analysis cell, for tuning the second modulated transmission signal to produce a substantially monochromatic second modulated transmission signal. The apparatus also comprises a second transmitted electromagnetic radiation detector, in communication with the tuner, for detecting the substantially mono-chromatic second modulated transmission signal to produce a second electrical modulated transmission sample signal representing the substantially monochromatic second modulated transmission signal. In this case, the lock-in amplifier is in communication with the second transmitted electromagnetic radiation detector, and is adapted to demodulate the second electrical modulated transmission sample signal to produce a second electrical demodulated transmission sample signal representing the spectral properties in transmission of the fluid.

For further preference, the fluid analysis cell is adapted to allow the modulated electromagnetic radiation signal to interact in reflection with a fluid within the fluid analysis cell, to produce a modulated reflection signal and the tuner is in communication with the fluid analysis cell, for tuning the modulated reflection signal to produce a substantially mono-chromatic modulated reflection signal. In this case, the apparatus also comprises a reflected electromagnetic radiation detector, in communication with the tuner, for detecting the substantially monochromatic modulated reflection signal to produce an electrical modulated reflection sample signal representing the substantially monochromatic modulated reflection signal. Also, the lock-in amplifier is adapted to demodulate the electrical modulated reflection sample signal to produce an electrical demodulated reflection sample signal representing the spectral properties of the fluid.

More preferably still, the apparatus comprises means for isolating the modulated reflection signal from the first and/or second modulated transmission signals, such that transmission and reflection measurements may be made simultaneously.

For still further preference, the source of electromagnetic radiation is a xenon short arc lamp, and the modulator is a chopper.

Even more preferably, the tuner is a monochromator.

According to a fourth aspect of the present invention, a method for measuring the spectral properties of a fluid comprises the steps of:
(i) producing an electromagnetic radiation signal from a source;
(ii) modulating the electromagnetic radiation signal to produce a modulated electromagnetic radiation signal;
(iii) detecting the modulated electromagnetic radiation signal to produce an electrical modulated phase reference signal representing the modulated electromagnetic radiation signal;
(iv) tuning the modulated electromagnetic radiation signal to produce a modulated substantially monochromatic electromagnetic radiation signal having a specified wavelength;
(v) interacting the modulated substantially monochromatic electromagnetic radiation signal in transmission with a fluid having a specified thickness, to produce a first modulated transmission signal;
(vi) detecting the first modulated transmission signal to produce a first electrical modulated transmission sample signal representing the first modulated transmission signal;
(vii) directing the electrical modulated phase reference and first electrical modulated transmission sample signals to a lock-in amplifier, for demodulating the first electrical modulated transmission sample signal to produce a first electrical demodulated transmission sample signal representing the spectral properties in trans-mission of the fluid at said specified wavelength; and
(viii) storing said first electrical demodulated transmission sample signal in a storage medium.

For preference, the method additionally comprises the steps of: detecting the modulated substantially monochromatic electromagnetic radiation signal to produce an electrical modulated electromagnetic radiation reference intensity signal representing the modulated substantially monochromatic electromagnetic radiation signal; and directing the electrical modulated electromagnetic radiation reference intensity signal to the lock-in amplifier, for compensating for intensity fluctuations in the source.

Preferably, the method additionally comprises the steps of:
(ix) repeating steps (iv) to (viii) for a specified range of wavelengths of electromagnetic radiation, to produce a first transmission curve representing the spectral properties in transmission of the fluid over that range at a specified first thickness of the fluid;
(x) comparing the first transmission curve with a first pre-defined transmission curve for a desired standard at the specified first thickness of the fluid;
(xi) adjusting the relative percentages of the components of the fluid based on the difference between the first transmission curve and the first pre-defined trans-mission curve; and
(xii) repeating steps (ix) to (xi) until the first transmission curve representing the spectral properties in transmission of the fluid over the specified range of wavelengths of electromagnetic radiation is substantially identical to the first pre-defined trans-mission curve for a desired standard at the specified first thickness of the fluid.

For further preference, the method comprises the steps of:
(xiii) changing the thickness of the fluid to a specified second thickness;
(xiv) repeating steps (iv) to (viii) for a specified range of wavelengths of electromagnetic radiation, to produce a second transmission curve representing the spectral properties in transmission of the fluid over the specified range at the specified second thickness of the fluid;
(xv) comparing the second transmission curve with a second pre-defined transmission curve for the desired standard at the specified second thickness of the fluid;
(xvi) adjusting the relative percentages of the components of the fluid based on the difference between the second transmission curve and the second pre-defined transmission curve;
(xvii) repeating steps (xiv) to (xvi) until the second transmission curve representing the spectral properties in transmission of the fluid over the specified range of wavelengths of electromagnetic radiation is substantially identical to the second pre-defined transmission curve for the desired standard at the specified second thickness of the fluid;
(xviii) changing the thickness of the fluid to the specified first thickness; and
(xix) repeating steps (ix) to (xii) and (xiii) to (xviii) until the first transmission curve representing the spectral properties in transmission of the fluid over the specified range of wavelengths of electromagnetic radiation is substantially identical to the first pre-defined transmission curve for a desired standard at the specified first thickness of the fluid, and the second transmission curve representing the spectral properties in transmission of the fluid over the specified range of wavelengths of electromagnetic radiation is substantially identical to the second pre-defined transmission curve for the desired standard at the specified second thickness of the fluid.

According to a fifth aspect of the present invention, a method for measuring the spectral properties of a fluid comprises, in addition to steps (i) to (viii), the steps of:
(xx) repeating steps (iv) to (viii) for a specified range of wavelengths of electromagnetic radiation, to produce a first sample transmission curve representing the spectral properties in transmission of the fluid over that range at a specified first thickness of the fluid;
(xxi) changing the thickness of the fluid to a specified second thickness;
(xxii) repeating steps (iv) to (viii) for a specified range of wavelengths of electromagnetic radiation, to produce a second sample transmission curve representing the spectral properties in transmission of the fluid over that range at the specified second thickness of the fluid;
(xxiii) comparing the first transmission curve with a first pre-defined transmission curve for a desired standard at the specified first thickness of the fluid, and comparing the second transmission curve with a second pre-defined transmission curve for a desired standard at the specified second thickness of the fluid;
(xxiv) adjusting the relative percentages of the components of the fluid based on the difference between the first transmission curve and the first pre-defined trans-mission curve, and the difference between the second transmission curve and the second pre-defined transmission curve; and
(xxv) repeating steps (xx) to (xxiv) until the first transmission curve representing the spectral properties in transmission of the fluid over the specified range of wavelengths of electromagnetic radiation is substantially identical to the first pre-defined transmission curve for a desired standard at the specified first thickness of the fluid, and the second transmission curve representing the spectral properties in transmission of the fluid over the specified range of wavelengths of electromagnetic radiation is substantially identical to the second pre-defined transmission curve for a desired standard at the specified second thickness of the fluid.

According to a sixth aspect of the present invention, a method for measuring the spectral properties of a fluid comprises, in addition to steps (i) to (viii), the steps of:
(xxvi) interacting the modulated substantially monochromatic electromagnetic radiation signal in reflection with the fluid having a specified thickness, to produce a modulated reflection signal;
(xxvii) detecting the modulated reflection signal to produce an electrical modulated reflection sample signal representing the modulated reflection signal;
(xxviii) directing the electrical modulated reflection sample signal to a lock-in amplifier for demodulating the electrical modulated reflection sample signal to produce an electrical demodulated reflection sample signal representing the spectral properties in reflection of the fluid at said specified wavelength; and
(xxix) storing the electrical demodulated reflection sample signal in a storage medium.

For preference, the method additionally comprises the steps of:
(xxx) repeating steps (iv) to (viii) for a specified range of wavelengths of electromagnetic radiation, to produce a transmission curve representing the spectral properties in transmission of the fluid over that range;
(xxxi) comparing the transmission curve with a pre-defined transmission curve for a desired standard at a specified thickness of the fluid;
(xxxii) repeating steps (xxvi) to (xxix) for the specified range of wavelengths of electromagnetic radiation, to produce a reflection curve representing the spectral properties in reflection of the fluid over that range;
(xxxiii) comparing the reflection curve with a pre-defined reflection curve for a desired standard at a specified thickness of the fluid;
(xxxiv) adjusting the relative percentages of the components of the fluid based on the difference between the transmission curve and the pre-defined transmission curve, and the difference between the reflection curve and the pre-defined reflection curve; and
(xxxv) repeating steps (xxx) to (xxxiii) until the transmission curve representing the spectral properties in transmission of the fluid over the specified range of wavelengths of electromagnetic radiation is substantially identical to the pre-defined transmission curve for a desired standard at the specified thickness of the fluid, and the reflection curve representing the spectral properties in reflection of the fluid over the specified range of wavelengths of electromagnetic radiation is substantially identical to the pre-defined reflection curve for the desired standard at the specified thickness of the fluid.

### BRIEF DESCRIPTION OF THE DRAWINGS

The present invention will now be described in greater detail, by way of example, with reference to the accompanying drawings, in which:

FIG. 1 shows a schematic diagram of a first embodiment of an apparatus for measuring the spectral properties of a fluid, according to the present invention, suitable for obtaining the transmission spectrum of a single transmitted component of electromagnetic radiation incident on the fluid;

FIG. 2 shows a schematic diagram of a second embodiment of the apparatus for measuring the spectral properties of a fluid, according to the present invention, suitable for obtaining the transmission spectrum of two transmitted components of electromagnetic radiation incident on the fluid;

FIG. 3 shows a schematic diagram of a third embodiment of the apparatus for measuring the spectral properties of a fluid, according to the present invention, suitable for obtaining the transmission spectrum of two transmitted components and the reflection spectrum of a reflected component of electromagnetic radiation incident on the fluid; and

FIG. 4 shows a schematic diagram of a fourth embodiment of the apparatus for measuring the spectral properties of a fluid, according to the present invention, suitable for obtaining the transmission spectrum of two transmitted components and the reflection spectrum of a reflected component of electromagnetic radiation incident on the fluid, the transmitted and reflected components of electromagnetic radiation passing through a monochromator before measurement.

### DETAILED DESCRIPTION OF THE INVENTION

Referring first to FIG. 1 of the drawings, an apparatus for measuring the spectral properties of a fluid, according to the presently preferred embodiment of the invention, comprises an electromagnetic radiation producing unit 1 which directs a portion of the electromagnetic radiation generated therein to a phase reference detector 3, connected via an amplifier 4 to a phase reference input port in a lock-in amplifier 5, and directs another portion of the electromagnetic radiation generated therein to a monochromator 6. A portion of the substantially single wavelength electromagnetic radiation exiting monochromator 6 is directed to an intensity reference detector 8, via a fibre-optic cable 7, intensity reference detector 8 being connected, via an amplifier 9, to an intensity reference input port in lock-in amplifier 5. The remainder of the substantially single wavelength electromagnetic radiation exiting monochromator 6 is directed to a fluid analysis cell 11, via fibre-optic cable 10, where it is incident on a fluid flowing there through. The electromagnetic radiation transmitted through the fluid is directed to a first transmitted electromagnetic radiation detector 13, via fibre-optic cable 12, first transmitted electromagnetic radiation detector 13 being connected, via an amplifier 14, to a first transmission sample input port in lock-in amplifier 5.

Electromagnetic radiation producing unit 1 comprises an electromagnetic radiation source (not shown) and a modulating means 2 for modulating said source. In the preferred embodiment of the present invention said source comprises a xenon short arc lamp and modulating means 2 comprises an electro-mechanical chopper having a series of blades, or a disk having slots cut therein, which may be rotated about an axis at a controlled velocity by a motor. It is also possible to use a Xenon flash lamp where the lamp itself is modulated at the desired frequency, thereby avoiding the need to use a chopper. Note that the source of electromagnetic radiation may be any source capable of emitting a spectrum of different wavelengths, and that modulating means 2 may comprise any mechanical, electromechanical or optical device that can be used to modulate the intensity of the electromagnetic radiation emitted from said source.

A xenon short arc lamp was chosen as the source due to its spectral emission characteristics, because it emits white light with a higher intensity than that emitted by common halogen lamps, and furthermore emits a higher intensity in the blue region of the spectrum, whereas in common halogen lamps the intensity of emission in the blue is substantially reduced, the radiation being predominantly in the red or infra-red regions of the electromagnetic spectrum. It is important to have relatively higher intensity radiation in the blue region of the spectrum, because current photo-detectors have relatively low sensitivity in the blue. Obviously, the choice of source depends to a large extent on the type of fluid being analysed and the sensitivity of the detectors available at the time. It should be noted that one disadvantage to using a xenon short arc lamp as the source is that it is not as stable in intensity as common halogen lamps, but tests proved that the source was sufficiently stable to allow measurement of the spectral characteristics of the paints and dispersions evaluated. In the event that greater intensity stability is required an integrating sphere 27 may be used at the output from electromagnetic radiation producing unit 1, as shown in FIG. 1.

Monochromator 6 is preferably a two stage monochromator so that the tuned electromagnetic radiation exiting there from is substantially monochromatic, thereby minimising the amount of electromagnetic radiation at other wavelengths so as to increase the signal-to-noise ratio of the system.

Detectors 3, 8 and 13 are common photo-diodes, and the electrical signals produced thereby are pre-amplified by respective electrical amplifiers 4, 9 and 14 before being directed to lock-in amplifier 5. Using photo-diodes it is possible to measure transmittances down to of the order of 0.0001% which is sufficient for all but the most opaque fluids. In order to be able to measure transmittances less than 0.0001% the apparatus of the present invention may be adapted to use photomultipliers in place of photo-diodes, thereby increasing significantly the signal to noise ratio, and allowing much smaller transmittances to be measured.

In the configuration shown in FIG. 1, lock-in amplifier 5 has three input ports, a first transmission sample input port, which receives the electrical signal coming from first transmitted electromagnetic radiation detector 13 via pre-amplifier 14, a phase reference input port, which receives the electrical signal coming from phase reference electromagnetic radiation detector 3 via pre-amplifier 4, and an auxiliary intensity reference input port, which receives the electrical signal coming from intensity reference detector 8 via pre-amplifier 9.

In operation, the first transmission sample electrical signal is demodulated by the phase reference signal, giving a resultant transmission sample signal representing the transmittance of the fluid under analysis at the chosen wavelength of electromagnetic radiation exiting monochromator 6. In order to give consistent measurements, independently of the source of electromagnetic radiation that is used, the intensity reference signal is used to compensate for variations in the intensity of electromagnetic radiation emitted by electromagnetic radiation producing unit 1. This allows adjustments to be made both during a measurement, and if a different source is used.

The great advantage of using a lock-in amplifier to measure the transmission spectra of opaque fluids is the ability to measure very small signals that are noisy, due to the dramatic increase in signal-to-noise ratio that can be obtained. There is, however, another advantage that makes the use of a lock-in amplifier even more attractive, this being the large input range of signals that can be measured, from 1 volt to 1 microvolt or less with the same amplifier. This is particularly useful in the present invention where it is necessary to calibrate the apparatus before commencing measurements of a batch of paint, enamel or dye. Calibrations are made using a transmission of 100%, where the fluid passing through fluid analysis cell 11 is a solvent (used during the cleaning process) which is practically transparent in the range of wavelengths of electromagnetic radiation that are commonly used. Thus, during calibration, the transmitted signal is very high.

The output signal from lock-in amplifier 5 is directed to a computer (not shown) where the transmittance at the wavelength under investigation is stored. The monochromator is then adjusted to a different wavelength by the computer, and a further measurement of transmittance is made using the lock-in amplifier at that different wavelength with the value of the transmittance being stored in the computer. This process is repeated, scanning the monochromator across the desired wavelength range, to build up a first sample transmittance curve. This first sample transmittance curve is then compared to a desired first standard transmittance curve for the final product at a specified first thickness of the sample fluid. In order to adjust the sample so that its transmittance curve corresponds to the desired transmittance curve, it is necessary to know how the curve will vary with the variation in the relative percentages of the fluid components (raw materials, normally colour pigments) in the sample. This information is stored in a database of reference transmittances for specific compositions which is available to the computer. Such a database can be created by performing a large number of measurements using the apparatus of the present invention to measure the variation in transmittance upon the addition of colorants to a base.

The effect obtained by addition of a greater percentage of a raw material to the fluid sample is referred to as the gain. In order to calculate the gain one approximates the variation in the sample transmission curve on addition of a colorant to an exponential. This approximation for the bands of additions necessary for adjusting the transmission curve of the sample is good when the sample is opaque, thereby requiring the thickness of the sample to be small. In such thin film conditions, taking as a basis the three flow theory of B. Maheu and G. Gouesbet, the most significant portion of the electromagnetic radiation transmitted through the fluid sample is that which is collimated-collimated (collimated incident radiation and collimated transmitted radiation), and in lesser degree that which is collimated-diffuse (collimated incident radiation and diffuse transmitted radiation). In the case of collimated-collimated radiation, the relationship between transmission and absorption coefficient, K, and multiple scattering coefficient, S, is given by the equation:

T_{cc}=exp[−(K+S)·z]·B (a)

where T_{cc} is the collimated-collimated transmission, z is the thickness of the film (optical path) and B is the proportion of the incident radiation that is collimated. In the apparatus of the present invention B is approximately equal to 1.

The gain on addition of a specific component to the sample is calculated by the difference in the curves using the formula:

gΔc=−[ln(T_{ccv})−ln(T_{ccs})] (b)

where T_{cc} is the collimated-collimated reference transmittance with respect to a specific fluid composition from the database, T_{ccs} is the collimated-collimated sample transmittance, g is the gain and Δc is the difference in composition between the reference and the sample. In order to obtain the best results possible, on each new formulation of a paint, enamel or dye, the gain is recalculated and added to the database, such that each new correction may be utilized as additional data for use in calculating the gain for future formulations.

On comparing the first sample transmittance curve with the first desired transmittance curve, the computer analyses the gain that should be necessary to make the first sample transmittance curve the same as the first desired transmittance curve, and, based on this necessary gain, controls the dosing of raw materials to the initial sample fluid which is mixed to provide a new sample fluid for analysis. The first sample transmittance curve of this adjusted sample is then obtained using the process described above, and the procedure is repeated until the first sample and desired first standard transmittance curves are substantially identical.

Once the computer establishes that the transmittance curves are substantially identical (within a given tolerance), it sends a control signal to fluid analysis cell 11 which adjusts the thickness of the sample fluid film to a second thickness, sufficient to have an effect on the transmittance curve of the sample. The process of obtaining an initial transmittance curve, comparing it with the desired transmittance curve for the new thickness, and adjusting the proportions of the components of the fluid, based on the necessary gain, is repeated until the second sample transmittance curve and the desired second standard transmittance curve for the second fluid film thickness are substantially identical.

The computer then sends a signal to fluid analysis cell 11 which adjusts the thickness of the sample fluid back to the first thickness, and the process of measuring the first sample transmittance curve and making any necessary adjustments based on the difference between the first sample transmittance curve and the desired first standard transmittance curve is repeated. Once the necessary adjustments have been made and the first sample transmittance curve is substantially identical to the first standard transmittance curve, the fluid film thickness is again changed to the second thickness and the second sample transmittance curve is obtained and compared with the second standard transmittance curve. This process of switching between thicknesses of the fluid sample and adjusting the sample such that its transmittance curve is substantially identical to the respective standard transmittance curve is repeated until no adjustments to the fluid components are necessary. At this point the sample is substantially identical to the standard for two distinct transmittance curves, and one can safely say that the sample fluid and the standard have the same colour, strength and hiding power.

As an alternative to the above method, on obtaining the first sample transmittance curve, the computer sends a control signal to fluid analysis cell 11 which adjusts the thickness of the sample fluid film to a second thickness, sufficient to have an effect on the transmittance curve of the sample. The process of obtaining an initial transmittance curve for the new thickness is repeated, and once both first and second sample transmittance curves have been obtained for the same sample at two different thicknesses, the computer compares the first sample transmittance curve with the desired first standard transmittance curve and the second sample transmittance curve with the desired second standard transmittance curve, analysing the gain that should be necessary to make the first sample transmittance curve the same as the desired first standard transmittance curve and the second sample transmittance curve the same as the desired second standard transmittance curve, and, based on this necessary gain, controls the dosing of raw materials to the initial sample fluid which is mixed to provide a new sample fluid for analysis. The first and second sample transmittance curves of this adjusted sample are then obtained using the process described above, and the procedure is repeated until both the first and second sample transmittance curves are substantially identical to the respective desired first and second standard transmittance curves.

It is also possible to measure absolute values for the absorption coefficient, K, and the scattering coefficient S, and consequently the strength and hiding power of the paint, enamel or dye, by making measurements of the transmittance at two distinct fluid film thicknesses. In this case, if one considers the behaviour to be according to the Kubelka-Munk theory then, by measuring the transmittance at two distinct thicknesses it is possible to use the following equations to determine K and S:

The scattering coefficient of the sample at the first and second thicknesses is given by

$$\begin{matrix}{S}_{1} - \frac{1}{{b}_{1} \cdot {z}_{1}} \cdot ( {sinh}^{- 1} ( \frac{{b}_{1}}{{T}_{1}} ) - {sinh}^{- 1} ( {b}_{1} ) ) and & ( c ) \\ {S}_{2} = \frac{1}{{b}_{2} \cdot {z}_{2}} \cdot ( {sinh}^{- 1} ( \frac{{b}_{2}}{{T}_{2}} ) - {sinh}^{- 1} ( {b}_{2} ) ) & ( d )\end{matrix}$$

respectively.

Since we are dealing with the same sample the transmittance of which is measured for two different sample thicknesses, then the Kubelka-Munk theory holds and we can say that a₁=a₂=a and S₁=S₂=S. Thus, on dividing the above equations we obtain the following:

$$\frac{{z}_{1}}{{z}_{2}} = \frac{{sinh}^{- 1} [ \frac{b}{{T}_{1}} ] - {sinh}^{- 1} ( b )}{{sinh}^{- 1} ( \frac{b}{{T}_{2}} ) - {sinh}^{- 1} ( b )} \qquad ( e )$$

where b is given by:

$$b = \sqrt{{( \frac{K}{S} )}^{2} + ( \frac{K}{S} )} . \qquad ( f )$$

Thus we have the objective function of the monovariable optimization, defined by the minimum square law as:

$$F ( \frac{K}{S} ) = {( \frac{\begin{matrix}{sinh}^{- 1} ( \sqrt{\frac{{( \frac{K}{S} )}^{2} + ( \frac{K}{S} )}{{T}_{1}}} ) - \\ {{sinh}^{- 1} ( \sqrt{{( \frac{K}{S} )}^{2} + ( \frac{K}{S} )} )}_{{z}_{1}}\end{matrix}}{\begin{matrix}{sinh}^{- 1} ( \frac{\sqrt{{( \frac{K}{S} )}^{2} + ( \frac{K}{S} )}}{{T}_{2}} ) - \\ {{sinh}^{- 1} ( \sqrt{{( \frac{K}{S} )}^{2} + ( \frac{K}{S} )} )}^{{z}_{2}}\end{matrix}} )}^{2} \qquad ( g )$$

From the ratios of absorption to scattering coefficients (K/S), calculated using the two transmission measurements at distinct fluid film thicknesses, one can calculate the infinite reflection of the sample, and consequently one is able to calculate the colour difference (ΔE) in relation to the reflectance of the desired standard, thereby obtaining the reflectance curve of the sample.

Having the reflectance curve, one can calculate b using the following formula:

$$b = \frac{1 - {R}^{2}}{2 \cdot R} \qquad ( h )$$

where R is the reflectance.

The scattering coefficient S can then be calculated using the equation:

$$S = \frac{1}{b \cdot {z}_{1}} \cdot ( {sinh}^{- 1} ( \frac{b}{{T}_{1}} ) - {sinh}^{- 1} ( b ) ) \qquad ( i )$$

and, using the calculated value of (K/S) from equation (g) and the value of S from equation (i), one can calculate the absolute value of the absorption coefficient, K, using the expression:

$$K = ( \frac{K}{S} ) \cdot S . \qquad ( j )$$

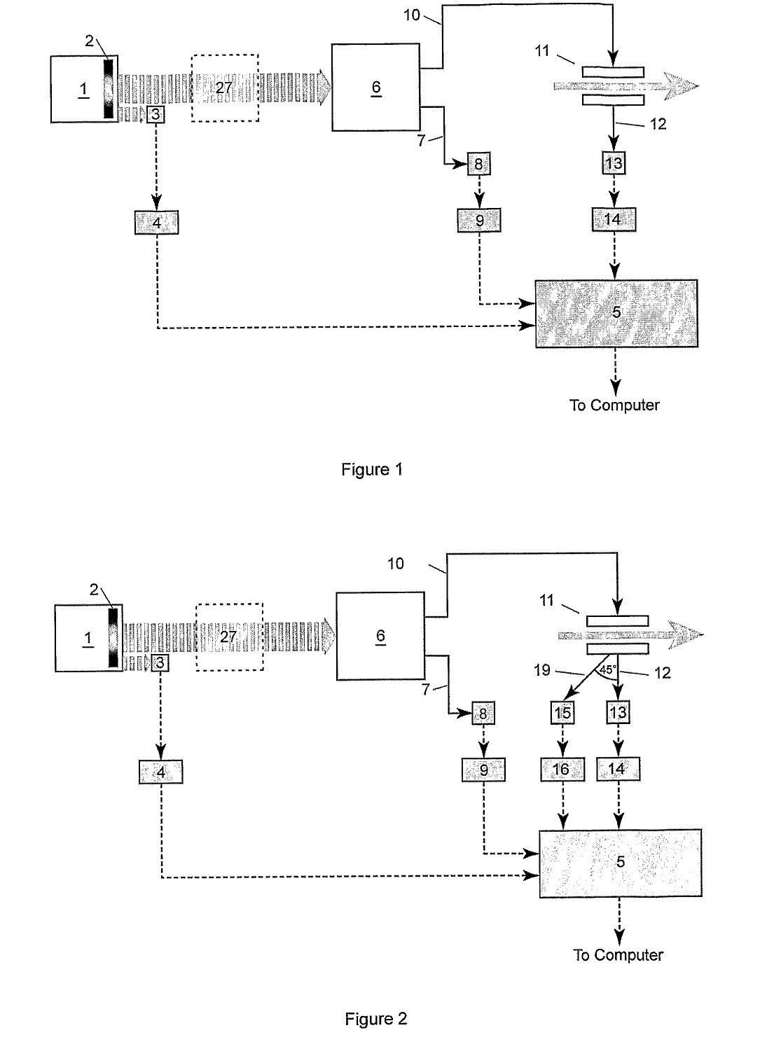

Referring now to FIG. 2, a second embodiment of the present invention comprises, in addition to first transmitted electromagnetic radiation detector 13, a second transmitted electromagnetic radiation detector 15 for detecting electromagnetic radiation transmitted through the sample at an angle to the incident direction. This enables scattered electromagnetic radiation to be detected, as well as straight through transmitted electromagnetic radiation, allowing measurements of different properties of the fluid under investigation to be made simultaneously with the normal absorption spectrum measurement. Normally, for paints, enamels or dyes, the peak in scattered electromagnetic radiation occurs at an angle of 45° to the incident direction, and the apparatus is therefore configured with second transmission sample detector 15 positioned to detect the 45° scattered electromagnetic radiation signal. Second transmitted electromagnetic radiation detector 15 is a common photo-diode which produces a second transmission sample electrical signal which is amplified by a pre-amplifier 16 before being directed to a second transmission sample input port in lock-in amplifier 5. The second transmission sample electrical signal is demodulated by the phase reference signal, giving a resultant scattered electromagnetic radiation transmission sample signal representing the scattered transmittance of the fluid under analysis at the chosen wavelength of electromagnetic radiation exiting monochromator 6.

The embodiment described above may be used where the collimated-diffuse transmitted electromagnetic radiation is significant, such as is the case for highly scattering paints, enamels or dyes.

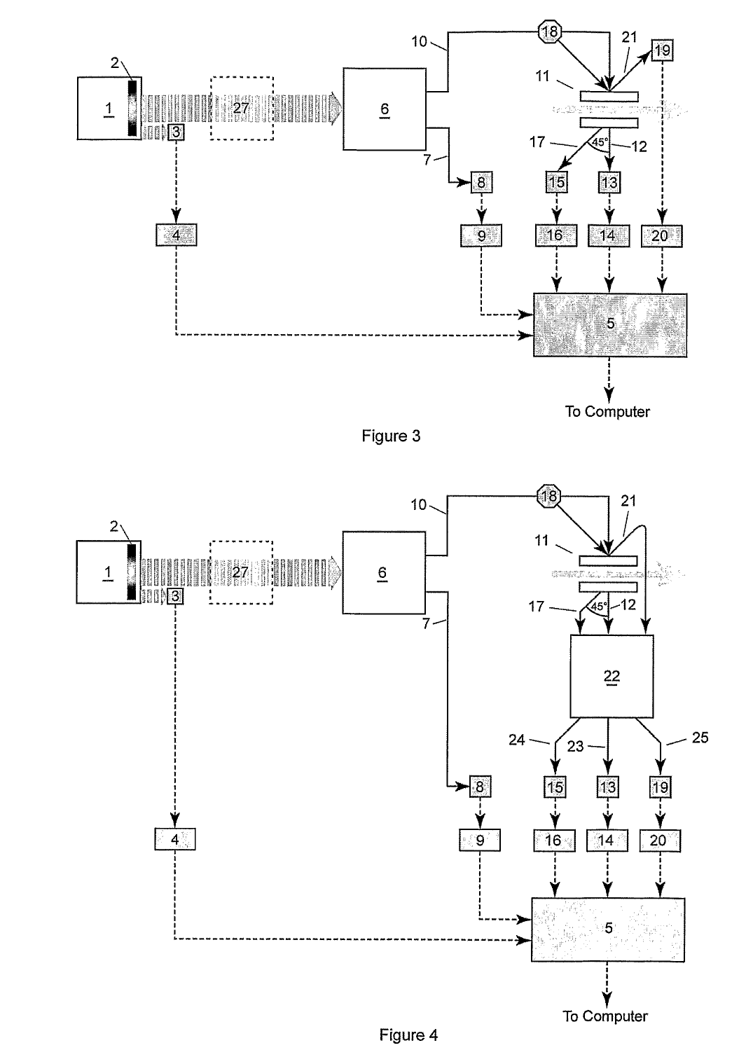

FIG. 3 shows a third embodiment of the apparatus according to the present invention in which electromagnetic radiation, exiting monochromator 6 via fibre-optic cable 10, may be directed to be incident on the sample over a range of angles, not solely normal incidence. This allows reflection measurements to be taken either separately or simultaneously with the transmission measurements. This is achieved using a switch 18 which can be used to direct all of the electromagnetic radiation exiting monochromator 6 to be incident on the sample at an angle to the normal, so as to produce a reflected component of electromagnetic radiation, or can be used to direct a part of the radiation into an incident reflection component and part into an incident transmission component so that measurements of the transmitted and reflected transmission and reflection components of the electromagnetic radiation may be measured at the same time.

As in the previous embodiments described above, the transmitted components of electromagnetic radiation are detected by first and second transmitted electromagnetic radiation detectors 13 and 15, and in the present embodiment the electromagnetic radiation reflected from the fluid is directed to a reflected electromagnetic radiation detector 19, via fibre-optic cable 21, for detecting the reflected component of electromagnetic radiation incident on the sample. This enables reflected electromagnetic radiation to be detected, as well as straight through transmitted and scattered electromagnetic radiation, allowing measurements of different properties of the fluid under investigation to be made simultaneously with the normal absorption spectrum and scattered radiation absorption spectrum measurements. Normally, for paints, enamels or dyes, reflection measurements are made with an incident angle to the normal to the sample of 45°, and the apparatus is therefore configured with reflected electromagnetic radiation detector 19 positioned to detect the 45° reflected electromagnetic radiation signal. Reflected electromagnetic radiation detector 19 is a common photo-diode which produces a reflection sample electrical signal which is amplified by a pre-amplifier 20 before being directed to a reflection sample input port in lock-in amplifier 5. The reflection sample electrical signal is demodulated by the phase reference signal, giving a resultant electromagnetic radiation reflection sample signal representing the reflectance of the fluid under analysis at the chosen wavelength of electromagnetic radiation exiting monochromator 6.

In order to enable transmission and reflection measurements to be carried out simultaneously, it may be necessary to isolate the reflection and transmission signals from each other. This may be achieved by using polarizers (not shown) or a polarizing beam-splitter (not shown) to give different, preferably perpendicular, polarizations to the transmission and reflection components of electromagnetic radiation incident on the sample, and using matching polarizers in front of the transmitted and reflected electromagnetic radiation detectors 13, 15 and 19 to isolate the correct polarization of electromagnetic radiation to be measured. Alternatively, physical isolation techniques may be used wherein the transmission measurements are made on one side of the sample, and reflection measurements are made on the opposite side as shown in FIG. 3.

In this embodiment, the thickness of the film is configured such that there is full hiding, that is to say, that the reflection measurements are taken for an infinite depth (from the point of view of the reflection measurement).

The output signals from the lock-in amplifier, representing the respective trans-mission and reflection signals, are directed to the computer where the transmittance and reflectance at the wavelength under investigation are stored. The monochromator is then adjusted to a different wavelength by the computer, and a further measurement of transmittance and reflectance is made using the lock-in amplifier at that different wavelength with the values of the transmittance and reflectance being stored in the computer. This process is repeated, scanning the monochromator across the desired wavelength range, to build up a sample transmittance curve and a sample reflectance curve.

In the same way as in the first embodiment of the present invention, the sample transmittance curve is compared with the desired standard transmittance curve with the addition that the sample reflectance curve is also compared with the desired standard reflectance curve. Thus, instead of taking two separate measurements of the transmittance curves at different thicknesses of sample fluid, a single transmittance curve is obtained together with a single reflectance curve. Again, adjustments are made to the proportions of the sample fluid components, and the transmittance and reflectance measurements repeated until both sample transmittance and sample reflectance curves are substantially identical to the desired standard transmittance and desired standard reflectance curves respectively, and no further adjustments are necessary. At this point the sample is substantially identical to the standard for both a transmittance and a reflectance curve, and one can safely say that the sample fluid and the standard have the same colour, strength and hiding power.

It is also possible to measure absolute values for the absorption coefficient, K, and the scattering coefficient S, and consequently the strength and hiding power of the paint, enamel or dye, by making measurements of the transmittance and reflectance of a fluid film having a specified thickness. In this case, by measuring the transmittance, T, and reflectance, R, it is possible to use the following equations to determine K and S:

$$\begin{matrix}( \frac{K}{S} ) = \frac{{( 1 - R )}^{2}}{2 \cdot R} & ( k ) \\ S = \frac{1}{b \cdot z} \cdot ( {sinh}^{- 1} ( \frac{b}{T} ) - {sinh}^{- 1} ( b ) ) & ( l ) \\ K = ( \frac{K}{S} ) \cdot S & ( m ) \\ where b = \frac{1 - {R}^{2}}{2 \cdot R} . & ( n )\end{matrix}$$

It is also possible to use the configuration shown in FIG. 3 for the purpose of taking reflection measurements of the fluid sample over a black background and a white background. In this case, no transmission measurements are made, with switch 18 directing all of the electromagnetic radiation from the monochromator onto the sample fluid in fluid sample cell 11. Two backgrounds are provided within sample cell 11 when it is used in the reflection only configuration, one black and the other white. In operation, the fluid film thickness is adjusted so that, for the particular fluid under investigation, the background affects the value of the reflectance. In other words, there must be reflection from the fluid film itself, and from the background. As in the first embodiment of the present invention, two separate measurements are made, but instead of measuring the transmittance and varying the thickness of the film, the reflectance is measured for the two different backgrounds. Again an iterative process is used, whereby a first sample reflectance curve is compared with a desired first standard reflectance curve, and a second sample reflectance curve is compared with a desired second standard reflectance curve, with adjustments being made to the proportions of the fluid components until the first sample reflectance curve is substantially identical to the first standard curve, and the second sample reflectance curve is substantially identical to the second standard reflectance curve. At this point the sample is substantially identical to the standard for both first and second reflectance curves, and one can safely say that the sample fluid and the standard have the same colour, strength and hiding power.

It is also possible to measure absolute values for the absorption coefficient, K, and the scattering coefficient S, and consequently the strength and hiding power of the paint, enamel or dye, by making measurements of the reflectance for two different backgrounds of a fluid film having a specified thickness. In this case, by measuring the reflectance, R, of the fluid film of thickness z, and knowing the reflectance of the background, R_{g}, it is possible to use the following equations to determine K and S:

$$\begin{matrix}R = \frac{1 - Rg \cdot ( a - b \cdot cot gh ( b \cdot S \cdot z ) )}{a - Rg + b \cdot cot gh ( b \cdot S \cdot z )} & ( o ) \\ where a = 1 + \frac{K}{S} & ( p ) \\ and b = \sqrt{{a}^{2} - 1} . & ( q )\end{matrix}$$

In some cases the fluid under investigation may be fluorescent, such as is the case with some dyes, and, in order to be able to measure correctly the transmittance at each wavelength of the spectrum under investigation, it is necessary to use either a two-stage or single stage monochromator 22 between fluid analysis cell (11) and detectors 13, 15 and/or 19 as shown in FIG. 4. In this case all components, normal transmitted, scattered transmitted and/or reflected, of the electromagnetic radiation from the sample are directed to monochromator 22 via fibre-optic cables 23, 24 and 25 respectively. Monochromator 22 can be used either in conjunction with monochromator 6, or can be used instead of monochromator 6, in which case electromagnetic radiation is directed directly from electromagnetic radiation producing unit 1 to the fluid analysis cell 11.

It should be observed that advantageous physical changes to the apparatus itself may be apparent to those skilled in the art, and as such, the scope of the present invention should be limited only by the terms and interpretation of the following claims.

1. An apparatus for measuring the spectral properties of a fluid comprising:
(i) an electromagnetic radiation producing means, comprising a source of electromagnetic radiation and a modulator, for producing a modulated electromagnetic radiation signal;
(ii) a phase reference electromagnetic radiation detector, in communication with said electromagnetic radiation producing means, for detecting said modulated electromagnetic radiation signal to produce an electrical modulated phase reference signal representing said modulated electromagnetic radiation signal;
(iii) a tuning means, in communication with said electromagnetic radiation producing means, for tuning said modulated electromagnetic radiation signal to produce a modulated substantially monochromatic electromagnetic radiation signal;
(iv) a fluid analysis cell, in communication with said tuning means, adapted to allow said modulated substantially monochromatic electromagnetic radiation signal, to interact in transmission with a fluid within said fluid analysis cell, to produce a first modulated transmission signal;
(v) a first transmitted electromagnetic radiation detector, in communication with said fluid analysis cell, for detecting said first modulated transmission signal to produce a first electrical modulated transmission sample signal representing said first modulated transmission signal; and
(vi) a lock-in amplifier, in communication with said phase references and said first transmitted electromagnetic radiation detectors, adapted to demodulate said first electrical modulated transmission sample signal to produce a first electrical demodulated transmission sample signal representing the spectral properties in transmission of said fluid.

2. An apparatus according to claim 1, comprising a reference intensity electromagnetic radiation detector, in communication with said tuning means, for detecting said modulated substantially monochromatic electromagnetic radiation signal to produce an electrical modulated electromagnetic radiation reference intensity signal representing said modulated substantially monochromatic electromagnetic radiation signal, said lock-in amplifier being in communication with said reference intensity electromagnetic radiation detector and being capable of using said modulated electromagnetic radiation reference intensity signal to compensate for intensity fluctuations of said source.

3. An apparatus according to claim 1, wherein said fluid analysis cell is adapted to allow said modulated substantially monochromatic electromagnetic radiation signal, to interact with a fluid within said fluid analysis cell, to produce a second modulated transmission signal simultaneously with said first modulated transmission signal, said apparatus comprising a second transmitted electromagnetic radiation detector, in communication with said fluid analysis cell, for detecting said second modulated transmission signal to produce a second electrical modulated transmission sample signal representing said second modulated transmission signal, said lock-in amplifier being in communication with said second transmitted electromagnetic radiation detector, and adapted to demodulate said second electrical modulated transmission sample signal to produce a second electrical demodulated transmission sample signal representing the spectral properties in transmission of said fluid.

4. An apparatus according to claim 1, wherein said fluid analysis cell is adapted to allow said modulated substantially monochromatic electromagnetic radiation signal, to interact in reflection with a fluid within said fluid analysis cell, to produce a modulated reflection signal, said apparatus comprising a reflected electromagnetic radiation detector, in communication with said fluid analysis cell, for detecting said modulated reflection signal to produce an electrical modulated reflection sample signal representing said modulated reflection signal, said lock-in amplifier being adapted to demodulate said electrical modulated reflection sample signal to produce an electrical demodulated reflection sample signal representing the spectral properties of said fluid.

5. An apparatus according to claim 4, comprising means for isolating said modulated reflection signal from said first and/or second modulated transmission signals, such that transmission and reflection measurements may be made simultaneously.

6. An apparatus according to claim 1, wherein said source of electromagnetic radiation is a xenon short arc lamp.

7. An apparatus according to claim 1, wherein said modulator is a chopper.

8. An apparatus according to claim 1, wherein said tuning means is a monochromator.

9. An apparatus for measuring the spectral properties of a fluid comprising:
(i) an electromagnetic radiation producing means, comprising a source of electromagnetic radiation and a modulator, for producing a modulated electromagnetic radiation signal;
(ii) a phase reference electromagnetic radiation detector, in communication with said electromagnetic radiation producing means, for detecting said modulated electromagnetic radiation signal to produce an electrical modulated phase reference signal representing said modulated electromagnetic radiation signal;
(iii) a first tuning means, in communication with said electromagnetic radiation producing means, for tuning said modulated electromagnetic radiation signal to produce a modulated substantially monochromatic electromagnetic radiation signal;
(iv) a fluid analysis cell, in communication with said tuning means, adapted to allow said modulated substantially monochromatic electromagnetic radiation signal, to interact in transmission with a fluid within said fluid analysis cell, to produce a first modulated transmission signal;
(v) a second tuning means, in communication with said fluid analysis cell, for tuning said first modulated transmission signal to produce a substantially monochromatic first modulated transmission signal;
(vi) a first transmitted electromagnetic radiation detector, in communication with said second tuning means, for detecting said substantially monochromatic first modulated transmission signal to produce a first electrical modulated transmission sample signal representing said substantially monochromatic first modulated transmission signal; and
(vii) a lock-in amplifier, in communication with said phase reference and said first transmitted electromagnetic radiation detectors, adapted to demodulate said first electrical modulated transmission sample signal to produce a first electrical demodulated transmission sample signal representing the spectral properties in transmission of said fluid.

10. An apparatus according to claim 9, comprising a reference intensity electromagnetic radiation detector, in communication with said first tuning means, for detecting said modulated substantially monochromatic electromagnetic radiation signal to produce an electrical modulated electromagnetic radiation reference intensity signal representing said modulated substantially monochromatic electromagnetic radiation signal, said lock-in amplifier being in communication with said reference intensity electromagnetic radiation detector and being capable of using said modulated electromagnetic radiation reference intensity signal to compensate for intensity fluctuations of said source.

11. An apparatus according to claim 9, comprising a reference intensity electromagnetic radiation detector, in communication with said second tuning means, for detecting said substantially monochromatic first modulated transmission signal to produce an electrical modulated electromagnetic radiation reference intensity signal representing said modulated substantially monochromatic electromagnetic radiation signal, said lock-in amplifier being in communication with said reference intensity electromagnetic radiation detector and being capable of using said modulated electromagnetic radiation reference intensity signal to compensate for intensity fluctuations of said source.

12. An apparatus according to claim 9, wherein said fluid analysis cell is adapted to allow said modulated substantially monochromatic electromagnetic radiation signal, to interact with a fluid within said fluid analysis cell, to produce a second modulated transmission signal simultaneously with said first modulated transmission signal, said apparatus comprising a second transmitted electromagnetic radiation detector, in communication with said second tuning means, for detecting said second modulated transmission signal to produce a second electrical modulated transmission sample signal representing said second modulated transmission signal, said lock-in amplifier being in communication with said second transmitted electromagnetic radiation detector, and adapted to demodulate said second electrical modulated transmission sample signal to produce a second electrical demodulated transmission sample signal representing the spectral properties in transmission of said fluid.

13. An apparatus according to claim 9, wherein said fluid analysis cell is adapted to allow said modulated substantially monochromatic electromagnetic radiation signal, to interact in reflection with a fluid within said fluid analysis cell, to produce a modulated reflection signal, said apparatus comprising a reflected electromagnetic radiation detector, in communication with said second tuning means, for detecting said modulated reflection signal to produce an electrical modulated reflection sample signal representing said modulated reflection signal, said lock-in amplifier being adapted to demodulate said electrical modulated reflection sample signal to produce an electrical demodulated reflection sample signal representing the spectral properties of said fluid.

14. An apparatus according to claim 13, comprising means for isolating said modulated reflection signal from said first and/or second modulated transmission signals, such that transmission and reflection measurements may be made simultaneously.

15. An apparatus according to claim 9, wherein said source of electromagnetic radiation is a xenon short arc lamp.

16. An apparatus according to claim 9, wherein said modulator is a chopper.

17. An apparatus according to claim 9, wherein said first and second tuning means are monochromators.

18. An apparatus for measuring the spectral properties of a fluid comprising:
(i) an electromagnetic radiation producing means, comprising a source of electromagnetic radiation and a modulator, for producing a modulated electromagnetic radiation signal;
(ii) a phase reference electromagnetic radiation detector, in communication with said electromagnetic radiation producing means, for detecting said modulated electromagnetic radiation signal to produce an electrical modulated phase reference signal representing said modulated electromagnetic radiation signal;
(iii) a fluid analysis cell, in communication with said electromagnetic radiation producing means, adapted to allow said modulated electromagnetic radiation signal, to interact in transmission with a fluid within said fluid analysis cell, to produce a first modulated transmission signal;
(iv) a tuning means, in communication with said fluid analysis cell, for tuning said first modulated transmission signal to produce a substantially monochromatic first modulated transmission signal;
(v) a first transmitted electromagnetic radiation detector, in communication with said tuning means, for detecting said substantially monochromatic first modulated transmission signal to produce a first electrical modulated transmission sample signal representing said substantially monochromatic first modulated transmission signal; and
(vi) a lock-in amplifier, in communication with said phase reference and said first transmitted electromagnetic radiation detectors, adapted to demodulate said first electrical modulated transmission sample signal to produce a first electrical demodulated transmission sample signal representing the spectral properties in transmission of said fluid.

19. An apparatus according to claim 18, comprising a reference intensity electromagnetic radiation detector, in communication with said electromagnetic radiation producing means, for detecting said electromagnetic radiation signal to produce an electrical modulated electromagnetic radiation reference intensity signal representing said modulated electromagnetic radiation signal, said lock-in amplifier being in communication with said reference intensity electromagnetic radiation detector and being capable of using said modulated electromagnetic radiation reference intensity signal to compensate for intensity fluctuations of said source.

20. An apparatus according to claim 18, wherein said fluid analysis cell is adapted to allow said modulated electromagnetic radiation signal, to interact with a fluid within said fluid analysis cell, to produce a second modulated transmission signal simultaneously with said first modulated transmission signal, said tuning means being in communication with said fluid analysis cell, for tuning said second modulated transmission signal to produce a substantially monochromatic second modulated transmission signal, said apparatus comprising a second transmitted electromagnetic radiation detector, in communication with said tuning means, for detecting said substantially monochromatic second modulated transmission signal to produce a second electrical modulated transmission sample signal representing said substantially monochromatic second modulated transmission signal, said lock-in amplifier being in communication with said second transmitted electromagnetic radiation detector, and adapted to demodulate said second electrical modulated transmission sample signal to produce a second electrical demodulated transmission sample signal representing the spectral properties in transmission of said fluid.

21. An apparatus according to claim 18, wherein said fluid analysis cell is adapted to allow said modulated electromagnetic radiation signal, to interact in reflection with a fluid within said fluid analysis cell, to produce a modulated reflection signal, said tuning means being in communication with said fluid analysis cell, for tuning said modulated reflection signal to produce a substantially monochromatic modulated reflection signal, said apparatus comprising a reflected electromagnetic radiation detector, in communication with said tuning means, for detecting said substantially monochromatic modulated reflection signal to produce an electrical modulated reflection sample signal representing said substantially monochromatic modulated reflection signal, said lock-in amplifier being adapted to demodulate said electrical modulated reflection sample signal to produce an electrical demodulated reflection sample signal representing the spectral properties of said fluid.

22. An apparatus according to claim 21, comprising means for isolating said modulated reflection signal from said first and/or second modulated transmission signals, such that transmission and reflection measurements may be made simultaneously.

23. An apparatus according to claim 18, wherein said source of electromagnetic radiation is a xenon short arc lamp.

24. An apparatus according to claim 18, wherein said modulator is a chopper.

25. An apparatus according to claim 18, wherein said tuning means is a monochromator.

26. A method for measuring the spectral properties of a fluid comprising the steps of:
(i) producing an electromagnetic radiation signal from a source;
(ii) modulating said electromagnetic radiation signal to produce a modulated electromagnetic radiation signal;
(iii) detecting said modulated electromagnetic radiation signal to produce an electrical modulated phase reference signal representing said modulated electromagnetic radiation signal;
(iv) tuning said modulated electromagnetic radiation signal to produce a modulated substantially monochromatic electromagnetic radiation signal having a specified wavelength;
(v) interacting said modulated substantially monochromatic electromagnetic radiation signal in transmission with a fluid having a specified thickness, to produce a first modulated transmission signal;
(vi) detecting said first modulated transmission signal to produce a first electrical modulated transmission sample signal representing said first modulated transmission signal;
(vii) directing said electrical modulated phase reference and first electrical modulated transmission sample signals to a lock-in amplifier, for demodulating said first electrical modulated transmission sample signal to produce a first electrical demodulated transmission sample signal representing the spectral properties in transmission of said fluid at said specified wavelength; and
(viii) storing said first electrical demodulated transmission sample signal in a storage medium.

27. A method according to claim 26, comprising the steps of:
detecting said modulated substantially monochromatic electromagnetic radiation signal to produce an electrical modulated electromagnetic radiation reference intensity signal representing said modulated substantially monochromatic electromagnetic radiation signal; and directing said electrical modulated electromagnetic radiation reference intensity signal to said lock-in amplifier, for compensating for intensity fluctuations in said source.

28. A method according to claim 26, additionally comprising the steps of:
(ix) repeating steps (iv) to (viii) for a specified range of wavelengths of electromagnetic radiation, to produce a first transmission curve representing the spectral properties in transmission of said fluid over said specified range of wavelengths of electromagnetic radiation at a specified first thickness of said fluid;
(x) comparing said first transmission curve with a first pre-defined transmission curve for a desired standard at said specified first thickness of said fluid;
(xi) adjusting the relative percentages of the components of said fluid based on the difference between said first transmission curve and said first pre-defined transmission curve; and
(xii) repeating steps (ix) to (xi) until said first transmission curve representing the spectral properties in transmission of said fluid over said specified range of wavelengths of electromagnetic radiation is substantially identical to said first pre-defined transmission curve for a desired standard at said specified first thickness of said fluid.

29. A method according to claim 28, comprising the steps of:
(xiii) changing said specified thickness of said fluid to a specified second thickness;
(xiv) repeating steps (iv) to (viii) for a specified range of wavelengths of electromagnetic radiation, to produce a second transmission curve representing the spectral properties in transmission of said fluid over said specified range of wavelengths of electromagnetic radiation at said specified second thickness of said fluid;
(xv) comparing said second transmission curve with a second pre-defined transmission curve for a desired standard at said specified second thickness of said fluid;
(xvi) adjusting the relative percentages of the components of said fluid based on the difference between said second transmission curve and said second pre-defined transmission curve;
(xvii) repeating steps (xiv) to (xvi) until said second transmission curve representing the spectral properties in transmission of said fluid over said specified range of wavelengths of electromagnetic radiation is substantially identical to said second pre-defined transmission curve for a desired standard at said specified second thickness of said fluid;
(xviii) changing said specified thickness of said fluid to said specified first thickness; and
(xix) repeating steps (ix) to (xii) and (xiii) to (xviii) until said first transmission curve representing the spectral properties in transmission of said fluid over said specified range of wavelengths of electromagnetic radiation is substantially identical to said first pre-defined transmission curve for a desired standard at said specified first thickness of said fluid, and said second transmission curve representing the spectral properties in transmission of said fluid over said specified range of wavelengths of electromagnetic radiation is substantially identical to said second pre-defined transmission curve for a desired standard at said specified second thickness of said fluid.

30. A method according to claim 26, additionally comprising the steps of:
(xx) repeating steps (iv) to (viii) for a specified range of wavelengths of electromagnetic radiation, to produce a first sample transmission curve representing the spectral properties in transmission of said fluid over said specified range of wavelengths of electromagnetic radiation at a specified first thickness of said fluid;
(xxi) changing said specified thickness of said fluid to a specified second thickness;
(xxii) repeating steps (iv) to (viii) for a specified range of wavelengths of electromagnetic radiation, to produce a second sample transmission curve representing the spectral properties in transmission of said fluid over said specified range of wavelengths of electromagnetic radiation at said specified second thickness of said fluid;
(xxiii) comparing said first transmission curve with a first pre-defined transmission curve for a desired standard at said specified first thickness of said fluid, and comparing said second transmission curve with a second pre-defined transmission curve for a desired standard at said specified second thickness of said fluid;
(xxiv) adjusting the relative percentages of the components of said fluid based on the difference between said first transmission curve and said first pre-defined transmission curve, and the difference between said second transmission curve and said second pre-defined transmission curve; and
(xxv) repeating steps (xx) to (xxiv) until said first transmission curve representing the spectral properties in transmission of said fluid over said specified range of wavelengths of electromagnetic radiation is substantially identical to said first pre-defined transmission curve for a desired standard at said specified first thickness of said fluid, and said second transmission curve representing the spectral properties in transmission of said fluid over said specified range of wavelengths of electromagnetic radiation is substantially identical to said second pre-defined transmission curve for a desired standard at said specified second thickness of said fluid.

31. A method according to claim 26 or 27, additionally comprising the steps of:
(xxvi) interacting said modulated substantially monochromatic electromagnetic radiation signal in reflection with a fluid having a specified thickness, to produce a modulated reflection signal;
(xxvii) detecting said modulated reflection signal to produce an electrical modulated reflection sample signal representing said modulated reflection signal;
(xxviii) directing said electrical modulated reflection sample signal to a lock-in amplifier, for demodulating said electrical modulated reflection sample signal to produce an electrical demodulated reflection sample signal representing the spectral properties in reflection of said fluid at said specified wavelength; and
(xxix) storing said electrical demodulated reflection sample signal in a storage medium.

32. A method according to claim 31, comprising the steps of:
(xxx) repeating steps (iv) to (viii) for a specified range of wavelengths of electromagnetic radiation, to produce a transmission curve representing the spectral properties in transmission of said fluid over said specified range of wavelengths of electromagnetic radiation;
(xxxi) comparing said transmission curve with a pre-defined transmission curve for a desired standard at a specified thickness of said fluid;
(xxxii) repeating steps (xxvi) to (xxix) for a specified range of wavelengths of electromagnetic radiation, to produce a reflection curve representing the spectral properties in reflection of said fluid over said specified range of wavelengths of electromagnetic radiation;
(xxxiii) comparing said reflection curve with a pre-defined reflection curve for a desired standard at a specified thickness of said fluid;
(xxxiv) adjusting the relative percentages of the components of said fluid based on the difference between said transmission curve and said pre-defined transmission curve, and the difference between said reflection curve and said pre-defined reflection curve; and
(xxxv) repeating steps (xxx) to (xxxiii) until said transmission curve representing the spectral properties in transmission of said fluid over said specified range of wavelengths of electromagnetic radiation is substantially identical to said pre-defined transmission curve for a desired standard at said specified thickness of said fluid, and said reflection curve representing the spectral properties in reflection of said fluid over said specified range of wavelengths of electromagnetic radiation is substantially identical to said pre-defined reflection curve for said desired standard at said specified thickness of said fluid.
